(19) United States
(12) Patent Application Publication
(10) Pub. No.: US 2024/0354088 A1
(43) Pub. Date: Oct. 24, 2024

(54) UPDATE AGENT DOWNLOAD SCHEME

(71) Applicant: GIESECKE+DEVRIENT MOBILE SECURITY GERMANY GMBH, München (DE)

(72) Inventors: Clara GIFRE, Barcelona (ES); David PATINO, Saint Vincenc dels Horts (ES); Federico RUAU, Hospitalet de Llobregat (ES)

(21) Appl. No.: 18/574,927

(22) PCT Filed: Jun. 29, 2022
(86) PCT No.: PCT/EP2022/025294

§ 371 Date: Dec. 28, 2023

(30) Foreign Application Priority Data
Jun. 30, 2021 (EP) 21382579.7

(51) Int. Cl. G06F 8/61

(52) U.S. Cl. CPC G06F 8/61

(57) ABSTRACT

A method, a data structure, and an update agent for implementing a scheme for downloading an operating system image onto a secure element. The update agent receives from an external device an installation package for installing an operating system onto the secure element. The update agent requests control of the secure element and loads the operating system received with the installation package into the secure element, after which control of the secure element is transferred to the operating system.

The present invention relates to updating a piece of software, such as an operating system, on a secure element, and, more particularly, to a method, a data structure, and an update agent for implementing a scheme for downloading an operating system image onto a secure element.

### BACKGROUND OF THE INVENTION

Recently, mobile devices configured to employ electronic subscriber profiles for communicating on mobile networks have emerged. Such mobile devices are typically equipped with smart cards containing electronic/embedded Secure Elements (SE), such as electronic/embedded universal integrated circuit cards (eUICCs), smartSD, or smart microSD, to name a few.

A secure element is a tamper resistant element, TRE, that provides a secure memory and execution environment within a smart card/device in which application code and application data can be securely stored and administered. The secure element ensures that access to the data stored on the card is provided only when authorized.

A secure element designed to be used in telecommunication products, such as mobile devices, is configured to store one or more electronic subscriber profiles, in particular electronic/embedded subscriber identification module (eSIM) profiles, that may allow mobile devices to connect to one or more mobile networks. A subscriber profile (e.g., eSIM profile) may be generated by a mobile network operator (MNO) and may be downloaded to a mobile network device. The subscriber profile may then be installed on the secure element of the mobile device and used for communication over a corresponding mobile network by the mobile device.

FIG. 1 shows a simplified representation of the architecture of a remote eSIM provisioning system as described in SGP.22 RSP Technical Specification, Version 2.0, issued by the GSM Association (in the following referred to as GSMA RSP 22). The eSIM provisioning system 1 is organized around several elements: the SM-DP+ (Subscription Manager-Data Preparation and Secure Routing, 11), the SM-DS (Subscription Manager-Discovery Server, 14), the LPA (Local Profile Assistance, 25) and the eUICC, 10, the latter being part of a mobile device 20, of an end user 13.

The SM-DP+ 11 is responsible for the creation, download, remote management (enable, disable, update, delete) and the protection of subscriber profiles provided by the MNO 12. In particular, the SM-DP+ 11 may be configured to provide a profile in a Bound Profile Package, and enable the Bound Profile Package to be securely transmitted.

The LPA (Local Profile Assistant, 25) is a set of functions in the device 20 responsible for providing the capability to download (encrypted) profiles to the eUICC/TRE/SE 10. It also presents the local management end user interface to the end user 13 so they can manage the status of profiles on the eUICC/TRE/SE 10. The SM-DS 14 provides means for the SM-DP+ 11 to communicate with the eUICC/TRE/SE 10.

Historically, the native implementation or the operating system of a TRE could not be updated once the TRE was deployed in the field, and hence, did not vary once the TRE has surpassed the production phase. This means that if any problem is found that is related to the software within it (new attacks or vulnerabilities, new updates on sector specification, the expected life cycle of the devices using it), the only possible action is to change the whole TRE. This makes it particularly difficult to keep up to date with the market needs in terms of production (with software updates after production being impossible), especially when the production is bound to be executed within a certified environment in the factory.

The GSMA remote provisioning architecture, depicted in FIG. 1, provides a platform for implementing a procedure to load profiles onto a secure element (SE) or Tamper Resistant Element (TRE), which however allows merely for implementing a change in the data stored in the SE/TRE but not in the basic software present in the SE/TRE. The procedure requires several exchanges between the TRE and the server before it can prepare the Bound Profile Package used for the load, which might not be optimal for a broadcast deploy of a new piece of software. This scheme also lacks extra layers of protection which might be required for the deployment of critical data such as a new operating system

It is therefore desirable to provide a solution for updating an operating system on a secure element, which addresses the above-mentioned drawbacks.

### SUMMARY OF THE INVENTION

The present invention addresses the above object by the subject-matter covered by the independent claims. Preferred embodiments of the invention are defined in the dependent claims.

According to a first aspect of the present invention, there is provided a method for downloading an operating system onto a secure element, the secure element comprising an update agent, which is configured to perform steps as follow. The update agent receives from an external device an installation package for installing an operating system onto the secure element.

The update agent requests control of the secure element and loads the operating system received with the installation package into the secure element, after which control of the secure element is transferred to the operating system.

The proposed method provides an efficient and secure solution for loading trusted software, in particular an operating system, onto a secure element once the production of the secure element is finished. By equipping the update agent with the capability to control the secure element, the update agent is for some time in charge of the secure element, which does not have an own files system. This allows for an efficient and secure loading, updating, and replacing of software within the secure element.

In some embodiments of the present invention, the installation package comprises a header part and a data-carrying part, wherein the header part comprises an initialize secure channel signature, and the data-carrying part comprises a plurality of image segments, wherein a sequence of consecutive image segments comprises a manifest, a manifest signature, and an image of the operating system to be loaded onto the secure element.

In some embodiments of the present invention, receiving the installation package comprises receiving a first part of the installation package comprising the header and a first sequence of the plurality of image segments, the first sequence carrying the manifest signature and the manifest. The update agent is further configured, after it has received the first part of the installation package, to verify the initialize secure channel signature and the manifest signature comprised in the header, using a first key, in particular an Elliptical Curve Digital Signature, ECDSA, key, stored in the update agent.

This provides the update agent with a control mechanism to ensure both the trustworthiness of the installation package as well as of the transmission channel.

In some embodiments of the present invention, requesting control of the secure element comprises sending by the update agent to the external device a request to perform a system reset.

Preferably, after the system reset an initial operating system contained within the secure element is deleted, and control of the secure element is assumed by the update agent.

In some embodiments of the present invention, loading the operating system comprises receiving after the system reset the complete installation package from the external device, the complete installation package comprising the plurality of image segments, wherein the plurality of image segments carries the manifest, the manifest signature and the image of the operating system, each image segment being protected with a pair of image protection keys. After receiving the installation package, the update agent verifies integrity of the installation package, extracts the operating system from the corresponding image segments, and stores the operating system into a memory of the secure element.

Preferably, the image protection keys are established between the external device and the secure element through a key agreement process and used to implement a protection scheme based on a SCP03t algorithm, to ensure integrity of the installation package.

A confidential communication mechanism can thus be set up between the external device and the update agent.

Preferably, the header further comprises a protected keys field, carrying the image protection keys.

In some embodiments of the present invention, the header of the installation package comprises further a package binding signature for authenticating the software installation package. Preferably, the package binding signature comprises a signature of the initialize secure channel field and/or the protected keys field. The update agent is configured to perform authentication of the software installation package by verifying the package binding signature using a second key, in particular an Elliptical Curve Digital Signature, ECDSA, key, stored in the update agent.

According to a second aspect of the present invention, there is provided a computer-implemented data structure for providing a software installation package, in particular an operating system installation package, to an update agent on a secure element. The data structure comprises a header part and a data-carrying part. The header part comprises an initialize secure channel field carrying information on the installation operation to be implemented and for performing key derivation at the secure element. The data-carrying part comprises a plurality of image segments, wherein a sequence of consecutive image segments comprises a manifest, a manifest signature, and an image of the software to be loaded onto the secure element.

Preferably, the header part comprises a protected keys field carrying image protection keys, for encrypting the software image.

Preferably, the header part comprises a package binding signature, comprising a signature of the initialize secure channel field and/or the protected keys field, for authenticating the software installation package.

In some embodiments of the present invention, the manifest contains information on the software image to be uploaded, in particular information for authenticating the software image and/or authenticating an issuer of the image. The “software image” refers to a generic data format encapsulating a software version and cryptographic data to be used by the update agent. A software image can be an image of an operating system, but also an image of an applet or other application to be installed onto the secure element.

According to a third aspect of the present invention, there is provided an update agent for downloading software, in particular an operating system, onto a secure element. The update agent is configured to receive through a data structure according to the second aspect an installation package for installing an operating system and to perform the method according to the first aspect. In particular, the update agent is configured to verify the installation package and request control of the secure element, load the operating system received with the installation package into the secure element, and transfer control of the secure element to the operating system.

In some embodiments of the present invention, the update agent is personalized with a plurality of cryptographic keys, selected from a set comprising at least a first key, for verifying the manifest signature and the initialize secure channel signature received with the installation package, a key pair, for key agreement for processing image segments of the installation package, a second key, for verifying the package binding signature. Preferably, the first key is an Elliptical Curve Digital Signature, ECDSA, key. Preferably, the second key is an Elliptical Curve Digital Signature, ECDSA, key. Preferably, the key pair for key agreement is an Elliptical Curve Key Agreement, ECKA, key pair.

The aspects and embodiments described herein provide an efficient and secure solution for updating software, in particular an operating system, in a secure element, and thus to keep the secure element up to date with the evolution of the market, as well as to provide patches and security and bug fixes at any point in the life cycle of the secure element.

It has to be noted that all the devices, elements, units and means described in the present application could be implemented in software or hardware elements or combination thereof. All steps which are performed by the various entities described in the present application as well as the described functionalities are intended to mean that the respective entity is adapted to or configured to perform the respective steps and functionalities.

Further aspects, features and advantages of the present invention will become apparent to those of ordinary skills in the art upon reviewing the following detailed description of preferred embodiments and variants of the present invention in conjunction with the accompanying figures.

### BRIEF DESCRIPTION OF THE DRAWINGS

Reference will now be made to the accompanying figures, in which

FIG. 1 shows a simplified representation of the architecture of a GSMA remote provisioning system;

FIG. 2 shows an architecture of a remote eSIM provisioning system according to an embodiment of the invention;

FIG. 3 shows a flow chart of a method for downloading an operating system onto a secure element according to an embodiment;

FIGS. 4 to 7 show further steps of the method of FIG. 3 according to preferred embodiments;

FIG. 8 shows a sequence diagram for implementing the method for downloading an operating system on the system architecture of FIG. 2 according to an embodiment; and

FIG. 9 shows a security scheme for performing software/OS update according to an embodiment.

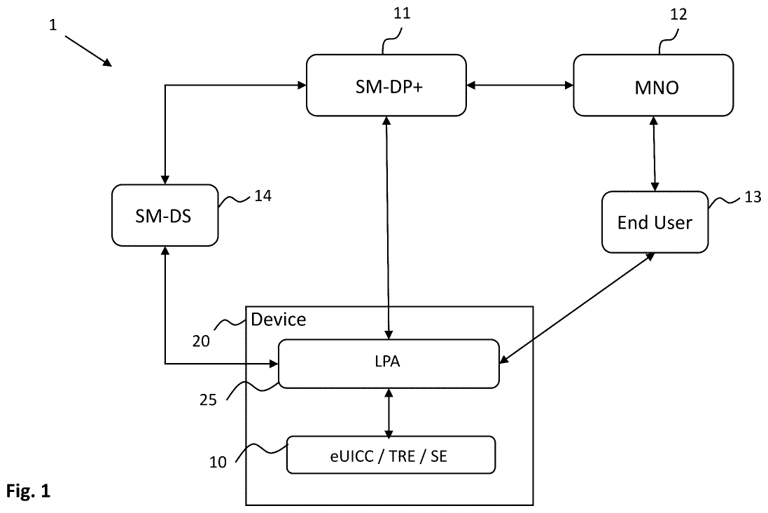

### DETAILED DESCRIPTION

Detailed explanations of the present invention are given below with reference to attached drawings that illustrate specific embodiment examples of the present invention. These embodiments are described in sufficient detail to enable those skilled in the art to practice the invention. It is to be understood that the various embodiments of the present invention, although different, are not necessarily mutually exclusive. For example, a particular feature, structure, or characteristic described herein in connection with one embodiment may be implemented within other embodiments without departing from the scope of the present invention. In addition, it is to be understood that the position or arrangement of individual elements within each disclosed embodiment may be modified without departing from the scope of the present invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

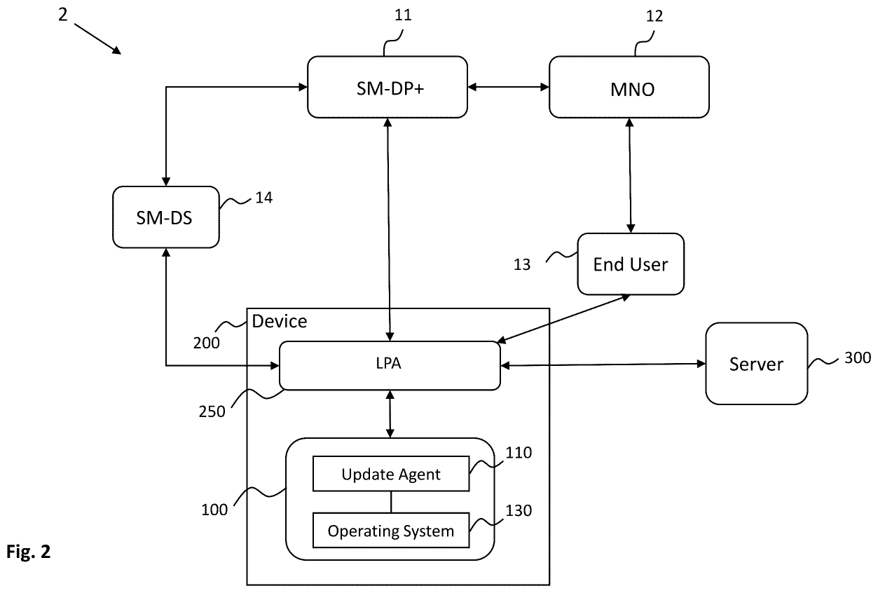

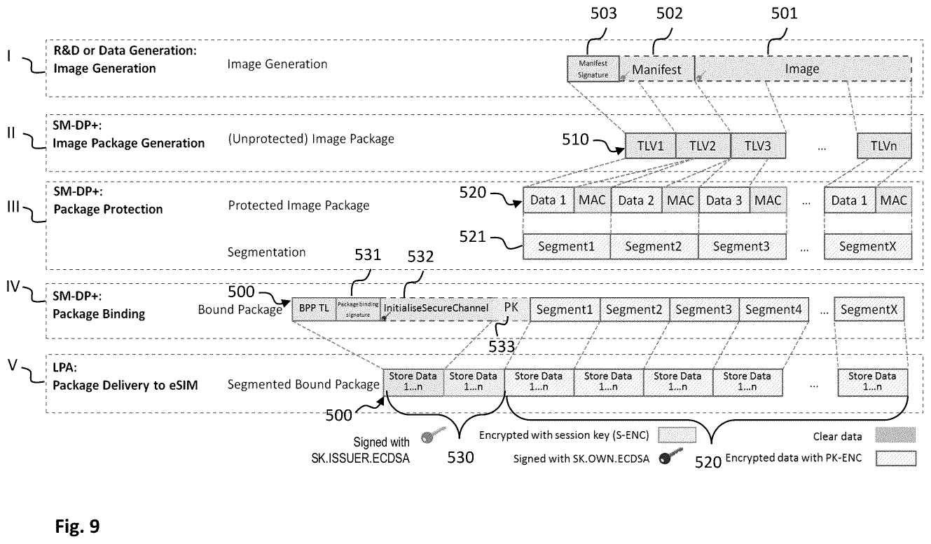

FIG. 9 shows a software update security scheme to provide a software image (e.g., OS image) for the update according to an embodiment. The scheme to provide the software image for the update adapts the general scheme known from GSMA RSP 22 to the architecture of FIG. 2.

The diagram in FIG. 9 illustrates the various formats a profile package (i.e., a Bound Installation Profile) will take from its generation to being download onto the secure element via the update agent. In particular, the Bound Installation Profile is created in several stages I to V beginning with the software image by performing several operations such as prepending and segmentation.

In the first stage I, the image 501, provided by an image issuer, is prepended with a manifest 502 and a manifest signature 501. The manifest 502 contains information pertaining to the new software image to be uploaded and ensures the image is acceptable and the issuer is trusted. The resulted block contains clear data that is not encrypted yet.

In stage II, the SM-DP+ 11 may generate, from the package obtained in stage I, an unprotected image package containing a sequence of profile element TLVs (Tag Length Values) TLV1, . . . , TLVn, 510. Preferably, the structure of the TLVs is in accordance with the SIMalliance eUICC Profile Package: Interoperable Format Technical Specification V2.0.

In stage III, the SM-DP+ 11 may generate from the unprotected package profile, a protected package profile, by applying TLV encryption and MACing. These operations may preferably follow the scheme described in GSMA “Remote Provisioning of Embedded UICC Technical specification” V3.1. Preferably, TLV encryption is done by applying a private profile protection key PK-ENC, generated by the SM-DP+ 11. The resulting data block is split into segments 1 to X, 521.

In stage IV the SM-DP+ 11 may generate a Bound Installation Profile package 500, by linking or binding the protected image package obtained in stage III to a particular eSIM/eUICC. This is done via a key agreement between the eSIM and the SM-DP+.

Finally, in stage V the Bound Installation Profile package 500, with header part 530 and data-carrying part 520, is segmented into blocks, and delivered to the update agent 110 on the eSIM or secure element 100. Preferably, the segments are sent via STORE DATA commands.

The above described process can be aimed to a set of targets (Broadcast) or to a specific target (Unicast), the only difference being the keys used for the process and the Remote Operation ID used in key derivation.

Table 1 shows the structure of a Bound Installation Package, obtained by the scheme of FIG. 9 described above. The table comprises TLV entries comprising a tag (T), a length (L), and a value field (Value Description).

TABLE 1
Structure of the Bound Installation Package

| | | | |
|---|---|---|---|
| T | L | Value Description | MOC |

| | | |
|---|---|---|
| ‘BF36’ | Var. | BP. All the data should not be at the same level than ‘BF23’. It should be |
| | | inside this TL. |

| | | | |
|---|---|---|---|
| T | L | Value Description | MOC |
| ‘BF51’ | Var. | Package Binding signature | O |
| ‘BF23’ | Var | InitialiseSecureChannel | M |
| ‘A2’ | Var. | secondSequenceOf87 | C |
| | | SHALL be absent if no content | |

| | | | |
|---|---|---|---|
| T | L | Value Description | MOC |
| ‘87’ | Var. | SCP03t segment containing | O |
| | | the Image Protection | |
| | | Keys, protected with session | |
| | | keys resulting from | |
| | | the key agreement (S- | |
| | | ENC, S-CMAC). (section | |
| | | 2.6.4). See [GSMA RSP]. | |
| | | Content: PK (TLV for | |
| | | “ES8+.ReplaceSes- | |
| | | sionKeys”) | |

| | | | |
|---|---|---|---|
| ‘A3’ | Var. | sequenceOf86 | M |

| T | L | Value Description | | MOC |
|---|---|---|---|---|
| ‘86’ | Var. | SCP03t | segment b1 | M |
| | | payload | protected | |
| | | | with Protection | |
| | | | keys (PK-ENC, | |
| | | | PK-MAC) or | |
| | | | with session | |
| | | | keys resulting | |
| | | | from the | |
| | | | key agreement | |
| | | | (S-ENC, S-CMAC). | |
| | | | (section 2.6.4). | |
| | | | See [GSMA RSP]. | |
| ‘86’ | Var. | | segment b2 | O |
| ‘86’ | Var. | | . . . | O |
| ‘86’ | Var. | | segment bn | O |

The entries in the table comprise:
a) Bound Package Signature (FIG. 9, Package Binding Signature 531) This part, with Tag or Data Group Identifier DGI ‘BF51’ is optional. It consists of a signature of the Initialize Secure Channel and the Protection Keys (if present) TLVs. Signed using the update agent's secrete key, SK.ISSUER.ECDSA and verified by its pair, a public key PK. Allow for the protection of the authentication part of the package.
b) Initialize Secure Channel (FIG. 9, 532)
   This part, with Tag or Data Group Identifier DGI BF23 defines a procedure used by the SM-DP+ to open a new Remote SIM Provisioning Session with the target eSIM and contains information for a set of session keys derivation. These keys might be used to secure the Protected Keys or, if these are not present, the sequence of image segments 541.

The procedure is an adaptation of the operation with the same name in [GSMA_RSP] section 5.5.1, with notable differences
(i) SharedInfo for key derivation (as defined in [GSMA_RSP] Annex G) uses the Remote Operation ID (Broadcast or Unicast) instead of the EID;
(ii) Transaction ID is stored and used to avoid replay attacks, given that for this scheme the key used for Key Agreement (SK.EUICC.ECKA) is fixed;
(iii) Transaction ID is reset when SK.EUICC.ECKA is updated;
(iv) Signature in tag 5F37 is performed with the update agent's secrete key SK.ISSUER.ECKA and shall be verified with its pair.

The Initialize Secure Channel Procedure is defined by the structure in Table 2.

TABLE 2
InitializeSecureChannelRequest

```
InitialiseSecureChannelRequest ::= [35] SEQUENCE { -- Tag ‘BF23’
  remoteOpId RemoteOpId, -- Remote Operation Type Identifier
  (value SHALL be set to installBoundProfilePackage)
  transactionId [0] TransactionId, -- The TransactionID generated by
  the SM-DP+
  controlRefTemplate[6] IMPLICIT ControlRefTemplate, -- Control
  Reference Template (Key Agreement). Current specification con-
  siders a subset of CRT specified in Global Platform Card Specifica-
  tion v2.2 Amendment E v1.0.1 as SharedInfo for the Mutual Au-
  thentication Data Field
  smdpPk [APPLICATION 73] OCTET STRING, ---
  otPK.DP.ECKA in Global Platform Card Specification v2.2
  Amendment E v1.0.1 (ePK.AP.ECKA for the mentioned specifica-
  tion), otPK.ISSUER.ECKA for this scheme. tag ‘5F49’
  smdpSign [APPLICATION 55] OCTET STRING -- SM-DP's sig-
  nature, with SK.ISSUER.ECDSA for this specification, tag ‘5F37’
}
ControlRefTemplate ::= SEQUENCE {
  keyType[0] Octet1, -- Key type according to GlobalPlatform Card
  Specification [8] Table 11-16, AES= ‘88’ , Tag ‘80’
  keyLen[1] Octet1, -- Key length in number of bytes. For current
  specification key length shall by 0x10 bytes, Tag ‘81’
  hostId[4] OctetTo16 -- Host ID value , Tag ‘84’
}
RemoteOpId ::= [2] INTEGER {broadcast(1), unicast(2)} - note that
this one differs from the definition in [GPC_SPE_042]
TransactionId ::= OCTET STRING (SIZE(1..16))
```

c) Protected Keys (FIG. 9, 533)
   Tag ‘A2’ contains the Image Protection Keys, which are the keys used to encrypt the software or OS image. If not present, the Image Protection Keys are equal to the derived session key set in the Initialize Secure Channel. If present, the Session Keys Template is a SCP03t secured (using the session key for encryption derived from the key agreement in Initialize Secure Channel) tag 87 TLV with the structure depicted in Table 3.

TABLE 3
ReplaceSessionKeysRequest

ReplaceSessionKeysRequest ::= [38] SEQUENCE { -- tag ‘BF26’

| | |
|---|---|
| - | The new initial MAC chaining value |

initialMacChainingValue OCTET STRING,

| | |
|---|---|
| - | New session key value for encryption/decryption (PK-ENC) |
| - | ppkEnc OCTET STRING, |
| - | New session key value of the session key C-MAC computation/ver- |
| | ification (PK-MAC) |
| - | ppkCmac OCTET STRING |

}

d) Sequence of Image Segments (FIG. 9, 521)
   Tag ‘A3’ contains the Manifest Signature 503, the Manifest 502, and the image 501 to be loaded divided in several segments. Each segment 521 comprises a TLV with tag 86 and is protected using SCP03t as defined in GSMA RSP 22, using either the session keys derived in the key agreement or the Image Protection Keys if present in the Bound Package. The content secured in a segment is an Unprotected Package, comprising the entries depicted in Table 4.

TABLE 4
Structure of an Unprotected Package (Stage II)

| T | ‘A4’ | |
|---|---|---|
| L | Length of the TLV in BER-TLV format | |
| V | Address | 4 bytes (little endian) |
| | Size | 4 bytes. Size of the content of the record (little endian) |

Content or pattern

If the length of the content is not consistent with the provided size, the record is a pattern record, where the content must be written as many times as necessary until the specified size is met. The first segment/s shall contain the manifest 502. The manifest 502 ensures the image is acceptable and the issuer is trusted.

The update agent 110 may receive an installation packages with the above-described structure, extract the operating system from the data-carrying part and download the operating system onto the secure element.

For being able to process an installation package with the above-described structure, the update agent may be personalized with a plurality of cryptographic keys. Examples of such keys may be:
a first key, for verifying the manifest signature and the initialize secure channel signature received with the installation package. The first key may be an Elliptical Curve Digital Signature, ECDSA, key, PK.KEY.ECDSA.
a key pair, preferably a multicast key pair, for key agreement for processing image segments of the installation package. This key pair may be an Elliptical Curve Key Agreement, ECKA, key pair, SK_MC.EUICC.ECKA.
a second key, for verifying the package binding signature. Preferably, the second key is an Elliptical Curve Digital Signature, ECDSA, key, PK.OWN.ECDSA.

The external entity 200 providing the installation package may dispose of the respective corresponding keys:
otSK.ISSUER.ECKA and otPK.ISSUER.ECKA: this is an one time key pair used to calculate the session key.
SK.ISSUER.ECDSA: this is a key used for signing the manifest (i.e., generating the manifest signature), the Initialize Secure Channel (i.e., generating the Initialize Secure Channel signature), and the image (i.e., generating the Image Signature).

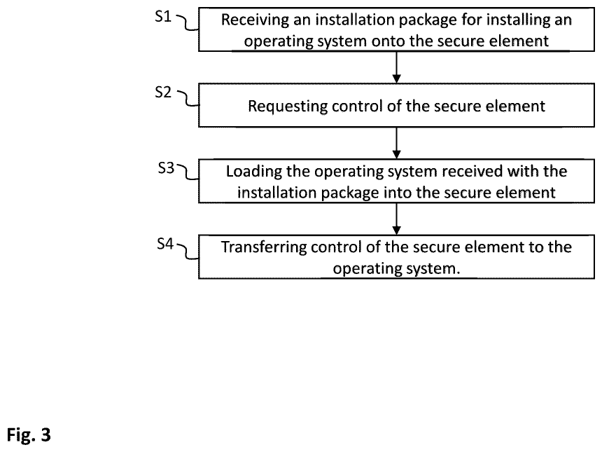

A method for downloading an operating system onto a secure element according to an embodiment will be described in the following with reference to FIGS. 3 to 8.

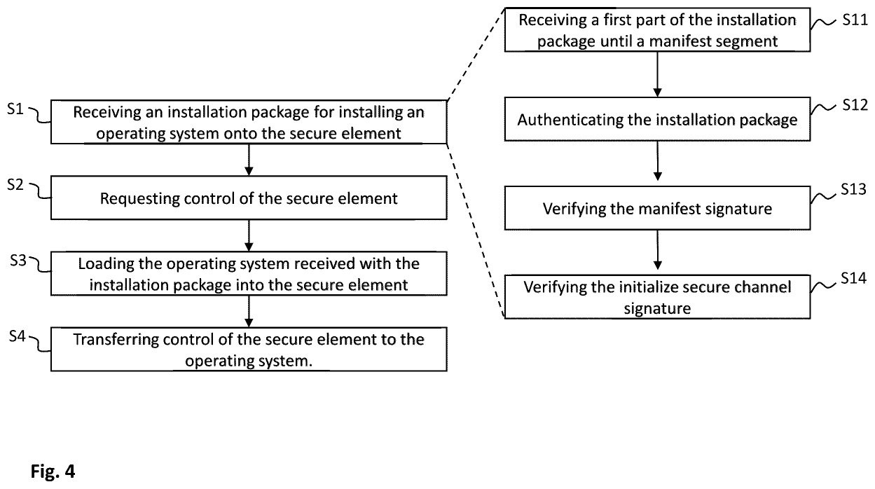

FIG. 3 shows a general flow chart of the method. FIGS. 4 to 7 show further steps of the method of FIG. 3 according to preferred embodiments.

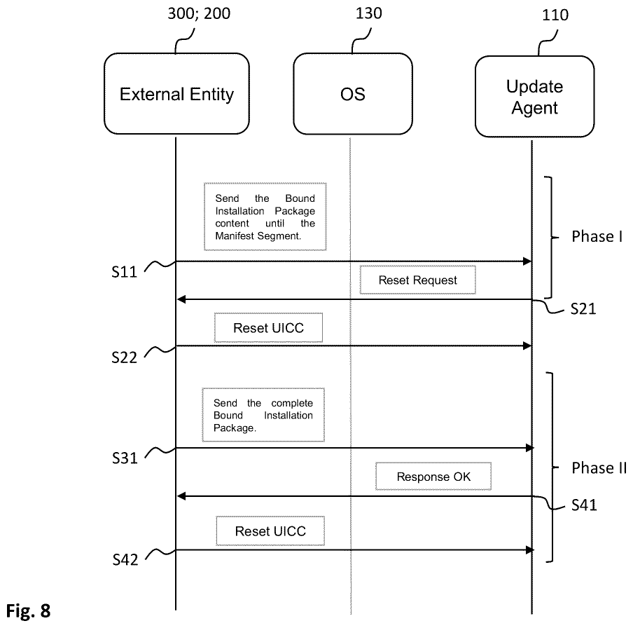

FIG. 8 shows a sequence diagram for implementing the method on the system architecture of FIG. 2 according to an embodiment.

With reference to FIG. 3, an installation package 500 for installing an operating system onto the secure element 100, is received at the update agent 110 in a first step S1. The installation package is sent from an entity external to the secure element, such as an image server 300 or an external device 200. The external device 200 may describe an entity which is in control and communicates with the SE 100. It can be a mobile terminal, or whatever device it is that the SE is mounted on.

The update agent 110 is the entity within the secure element 100 (separated from the OS) in charge of receiving the installation package and performing the software update. The update agent is loaded onto the secure element or TRE together with an (initial) Operative System (OS, 130 in FIG. 2), during the factory production of the secure element 100. Initially, the OS 130 is assumed to be in control, meaning it is the OS which is executed when the TRE 100 boots.

Thus, the update agent, upon receiving the installation package containing the new operating system, requests in step S2 control of the secure element to be transferred from the initial operating system to the update agent 110. Being in control of the secure element, which does not have a file system at all, the update agent may then load in step S3 the new operating system into the secure element. After the new operating system has been loaded in the secure element, the update agent transfers in step S4 the control to the new operating system.

The above-described method may be implemented by the update agent 110 in two phases, as depicted in FIG. 8.

In phase I, the update agent 110 receives in step S11 (which is a sub-step of step S1, c.f., FIG. 4) a first part of the installation package until and including the segment containing the manifest 502. That is, the update agent receives the header part 530 and initials segments of the data-carrying part 520, up to the segment comprising the manifest 502.

In a sub-step S13 (c.f., FIG. 4) of step S1, the update agent verifies the signature 503 of the manifest, to ensure that the image is acceptable and the issuer is trusted. Preferably, the update agent uses a first key stored in the update agent for verifying the manifest. The first key may be an Elliptical Curve Digital Signature, ECDSA, key, stored in the update agent.

The update agent may in addition verify the initialize secure channel signature 532 also by using the first key (step S14 in FIG. 4).

Optionally, the update agent may authenticate the installation package in a step S12, performed after receiving the first part of the installation package, by verifying the package binding signature using a second key, in particular an Elliptical Curve Digital Signature, ECDSA, key, stored in the update agent 110.

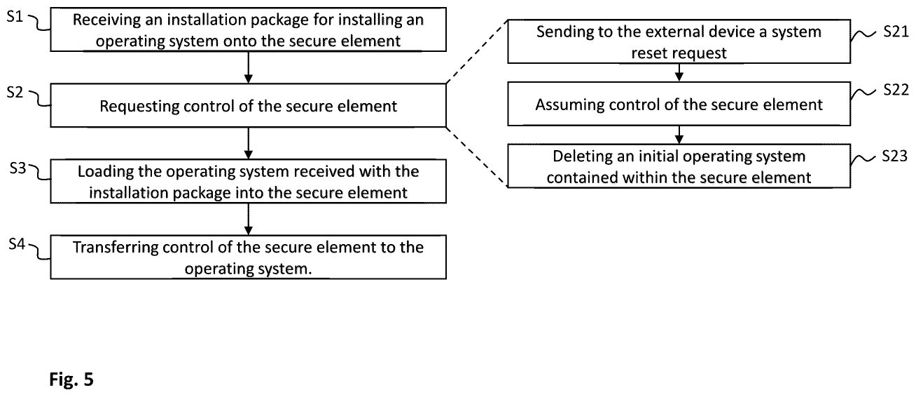

After the signatures have been verified, the update agent requests control of the secure element (step S2 in FIG. 3). This may be implemented by steps S21 to S23 in FIG. 5.

With reference to FIG. 5, the update agent indicates to the external device that a reset is required, to switch control from the initial operating system to the update agent, step S21. A reset is performed in step S22, through which the update agent 110 assumes control of the secure element 100. Upon assuming control of the secure element, the update agent 100 may delete the initial operating system 130.

With above sub-steps S11, S12, S13, S21, S22, S23 phase I in FIG. 8 is completed.

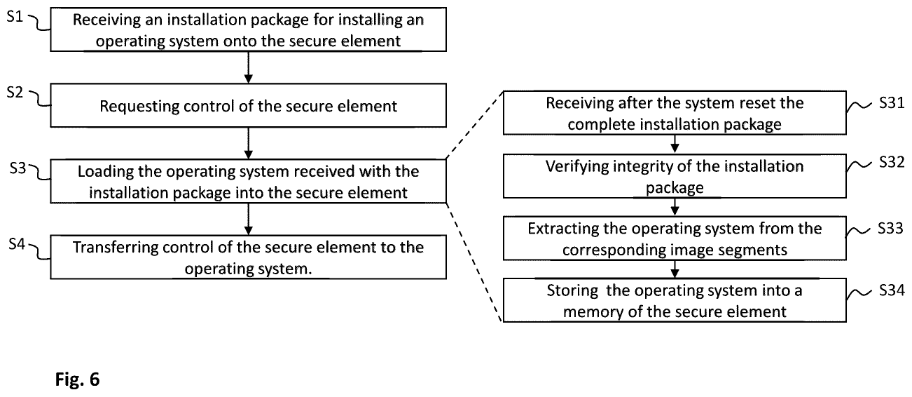

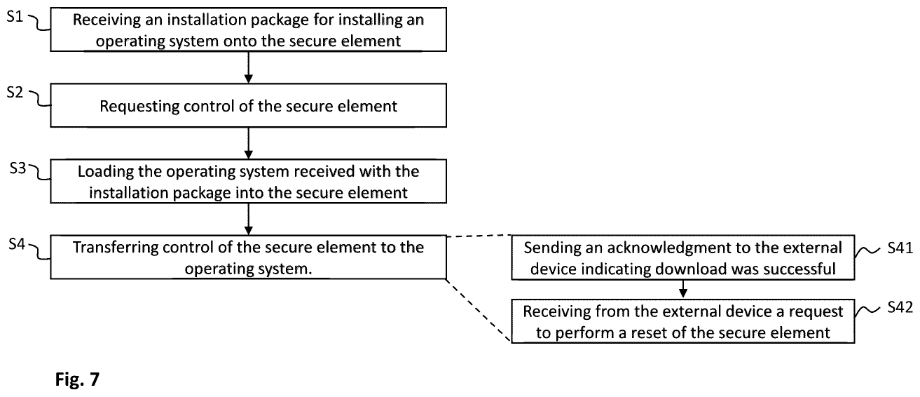

Phase II in FIG. 8 begins after the restart has been performed, and may be implemented as depicted by the steps of FIGS. 6 and 7.

In particular, the update agent may receive (S31 in FIG. 6) the installation package again from the external device. This time, however, the complete installation package 500 is received, comprising the plurality of image segments 521, wherein the plurality of image segments carries the manifest 502, the manifest signature 503 and the (new) image 501 of the operating system. Each image segment may be protected with a pair of image protection keys 533.

In step S32, the update agent 110 verifies integrity of the installation package. A set of keys may be used to establish integrity of the installation package. Preferably, the set of key (e.g., a multicast key pair) is established between the external device 200 and the secure element 100 through a key agreement process and may be used to implement a protection scheme based on a SCP03t algorithm, to ensure integrity of the installation package 500. To be able to process the installation package, the update agent is personalized with this key pair, as will be described later.

After verifying integrity of the installation package, the update agent 110 extracts in step S33 the operating system from the corresponding image segments 501, and stores the (new or updated) operating system into a memory of the secure element in step S34.

After successfully completing the operating system download, the update agent 110 transfers control of the secure element 100 to the operating system, step S4 in FIG. 3. The control transfer may be implemented by the steps S41 to S43 illustrated in FIG. 7.

With reference to FIG. 7, the update agent 110, indicates to the external device that the download was completed, step 41. A reset may be necessary, step S42, for the control of the secure element to be transferred to the newly installed operating system. Phase II in FIG. 8 is therewith completed.

In the above exemplified embodiments of FIGS. 4 to 7 for implementing the method for downloading an operating system of FIG. 3, the update agent receives from the external device the installation package segment by segment, wherein in phase I of FIG. 8, the first segments of the installation package are received up to and including the manifest. After the update agent proceeds and accepts the manifest, the system is restarted, and during phase II the update agent receives the complete installation package, and extracts the operating system contained therein.

In an alternative implementation embodiment of the method in FIG. 3, the update agent may receive the complete installation package during phase I, store it in a local memory, and process the installation package segment by segment until and including the segment containing the manifest. In this case, step S11 of FIG. 4 may be slightly different, requesting the update agent to process the installation package until the manifest segment is reached. The remaining steps S12 to S14 may remain unchanged. After the system reset, during which the update agent assumes control of the secure element, there is no need for the external device to send the entire installation package anymore, as the update agent has already received it. Step S31 in FIG. 6 may become obsolete. All the remaining steps and sub-steps illustrated in connection with the first implementation embodiment may be performed in the same way within the alternative implementation.

The aspects and embodiments described herein provide an efficient and secure solution for updating software, in particular an operating system, on a secure element at any time point after production of the secure element, and thus to keep the secure element up to date with the evolution of the market, as well as to provide patches and security and bug fixes at any point in the life cycle of the secure element.

In the foregoing specification, the invention has been described with reference to specific embodiments thereof. It will, however, be evident that various modifications and changes may be made thereto without departing from the broader scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1.-15. (canceled)

16. A method for downloading an operating system onto a secure element, the secure element comprising an update agent, the method comprising the steps performed by the update agent:
receiving from an external device an installation package for installing an operating system onto the secure element;
requesting control of the secure element;
loading the operating system received with the installation package into the secure element; and
transferring control of the secure element to the operating system.

17. The method according to claim 16, wherein the installation package comprises a header part and a data-carrying part,
wherein the header part comprises an initialize secure channel signature, and the data-carrying part comprises a plurality of image segments,
wherein a sequence of consecutive image segments comprises a manifest, a manifest signature, and an image of the operating system to be loaded onto the secure element.

18. The method according to claim 17, wherein receiving the installation package comprises receiving a first part of the installation package comprising the header and a first sequence of the plurality of image segments, the first sequence comprising the manifest signature and the manifest; and
wherein the method further comprises verifying the installation package by verifying the initialize secure channel signature and the manifest signature using a first key, in particular an Elliptical Curve Digital Signature, EC-DSA, key, stored in the update agent.

19. The method according to claim 16, wherein requesting control of the secure element comprises sending to the external device a request to perform a system reset.

20. The method according to claim 19, further comprising assuming control of the secure element and deleting an initial operating system contained within the secure element after the system reset.

21. The method according to claim 17, wherein loading the operating system comprises:
receiving after the system reset the complete installation package from the external device, the complete installation package comprising the plurality of image segments,
wherein the plurality of image segments carries the manifest, the manifest signature and the image of the operating system, each image segment being protected with a pair of image protection keys;
verifying integrity of the installation package;
extracting the operating system from the corresponding image segments; and
storing the operating system into a memory of the secure element.

22. The method according to claim 21, wherein the image protection keys are established between the external device and the secure element through a key agreement process and used to implement a protection scheme based on a SCP03t algorithm, to ensure integrity of the installation package.

23. The method according to claim 21, wherein the header of the installation package comprises further a package binding signature, the method further comprising authenticating the installation package by verifying the package binding signature using a second key, in particular an Elliptical Curve Digital Signature, ECDSA, key, stored in the update agent.

24. A computer-implemented data structure for providing a software installation package, in particular an operating system installation package, to an update agent on a secure element, the data structure comprising:
a header part comprising an initialize secure channel field carrying information on the installation operation to be implemented and for performing key derivation at the secure element; and
a data-carrying part comprising a plurality of image segments, wherein a sequence of consecutive image segments comprises a manifest, a manifest signature, and an image of the software to be loaded onto the secure element.

25. The computer-implemented data structure according to claim 24, wherein the header part further comprises a protected keys field carrying image protection keys, for encrypting the software image.

26. The computer-implemented data structure according to claim 24, wherein the header part further comprises a package binding signature, comprising a signature of the initialize secure channel field and/or the protected keys field, for authenticating the software installation package.

27. The computer-implemented data structure according to claim 24, wherein the manifest contains information on the software image to be uploaded, in particular information for authenticating the software image and/or authenticating an issuer of the image.

28. An update agent for downloading software, in particular an operating system, onto a secure element, the update agent being configured to:
receive through a data structure according to claim 24, an installation package for installing an operating system;
verify the installation package and request control of the secure element;
load the operating system received with the installation package into the secure element; and
transfer control of the secure element to the operating system.

29. The update agent according to claim 28, being personalized with a plurality of cryptographic keys, selected from a set comprising at least:
a first key, in particular an Elliptical Curve Digital Signature, ECDSA, key, for verifying the manifest signature and the initialize secure channel signature within the installation package;
a key pair, in particular an Elliptical Curve Key Agreement, ECKA, key pair, for processing image segments of the installation package; and
a second key, in particular an Elliptical Curve Digital Signature, ECDSA, key, for verifying the package binding signature.

30. The update agent according to claim 29, being configured to carry out a method for downloading an operating system onto a secure element, the secure element comprising an update agent, the method comprising the steps performed by the update agent:
receiving from an external device an installation package for installing an operating system onto the secure element;
requesting control of the secure element;
loading the operating system received with the installation package into the secure element; and
transferring control of the secure element to the operating system;
wherein the installation package comprises a header part and a data-carrying part,
wherein the header part comprises an initialize secure channel signature, and the data-carrying part comprises a plurality of image segments,
wherein a sequence of consecutive image segments comprises a manifest, a manifest signature, and an image of the operating system to be loaded onto the secure element.
